(19) United States
(12) Patent Application Publication
(10) Pub. No.: US 2025/0200195 A1
(43) Pub. Date: Jun. 19, 2025

(54) AUTOMATED COMPLIANCE MECHANISM FOR INDUSTRIAL SYSTEMS

(71) Applicant: DISH Wireless L.L.C., Englewood, CO (US)

(72) Inventor: Mark Bryce Stewart, Parker, CO (US)

(21) Appl. No.: 18/790,781

(22) Filed: Jul. 31, 2024

Related U.S. Application Data
(60) Provisional application No. 63/610,810, filed on Dec. 15, 2023.

(51) Int. Cl. G06F 21/60; G06F 21/55

(52) U.S. Cl. CPC G06F 21/604; G06F 21/554

(57) ABSTRACT

This disclosure relates to implementing security controls to meet security and privacy criteria. In some aspects, a method includes obtaining, by one or more computing devices, attributes of a target system. The method includes determining, based on the attributes of the target system, a plurality of security and privacy criteria associated with maintaining compliance with a set of target protocols. The method includes identifying, from a set of security controls, a subset of security controls in accordance with the plurality of security and privacy criteria. The method includes determining a priority associated with each of the security controls in the subset of security controls, wherein the priority for each of the security controls is determined based on the attributes of the target system and relationships of the security control with the set of target protocols. The method includes implementing the subset of security controls to the target system.

### CROSS-REFERENCE TO RELATED APPLICATION

This application claims priority to U.S. Provisional Application No. 63/610,810, filed Dec. 15, 2023.

### TECHNICAL FIELD

This specification generally relates to security and privacy of a target system.

### BACKGROUND

In the ever-evolving landscape of data privacy and security, regulatory compliance has become a paramount concern for organizations. For example, the regulatory compliance requirements may include a set of protocols for ensuring the protection of the system from potential threats, vulnerabilities, and breaches while safeguarding sensitive information.

### SUMMARY

In one aspect, this document describes a method for implementing security controls to meet security and privacy criteria. The method includes obtaining, by one or more computing devices, attributes of a target system. The method includes determining, based on the attributes of the target system, a plurality of security and privacy criteria associated with maintaining compliance with a set of target protocols. The method includes identifying, from a set of security controls, a subset of security controls in accordance with the plurality of security and privacy criteria. The method includes determining a priority associated with each of the security controls in the subset of security controls, wherein the priority for each of the security controls is determined based on the attributes of the target system and relationships of the security control with the set of target protocols. The method includes implementing the subset of security controls to the target system.

Other embodiments of this aspect include corresponding computer systems, apparatus, computer program products, and computer programs recorded on one or more computer storage devices, each configured to perform the actions of the method. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, the plurality of security and privacy criteria can include requirements for risk assessment, information security program, data protection, employee training, and incident response. In some implementations, the set of security controls can include pre-defined security controls related to cyber security.

In some implementations, selecting the subset of security controls can include: cross referencing each of the plurality of security and privacy criteria with each control included in the set of security controls to determine a relevance; and selecting the subset of security controls according to the relevance.

In some implementations, the method can include customizing the subset of security controls using technology infrastructure and operational requirements of the target system.

In some implementations, the method can include determining an implementation plan for the subset of security controls including: assessing current level of compliance, defining gaps in compliance, assigning responsibilities, setting timelines, defining milestones, and allocating resources.

In some implementations, the method can include continuously monitoring an effectiveness of the implemented subset of security controls according to the target system's compliance with the set of target protocols after implementing the subset of security controls.

Particular implementations of the subject matter described in this disclosure can be implemented so as to realize one or more of the following advantages. By implementing security controls that are selected from a large pool in accordance with requirements and/or characteristics of a target system, the technologies described in this document can ensure proper compliance with regulatory requirements for the target system associated with an organization. The technologies not only reduce the complexity and time associated with conducting comprehensive risk assessments—as compared to manual implementation of compliance measures—but also offer a high degree of confidence in the automated compliance measures. For example, the technologies described herein can be utilized to identify relevant security controls from a large pool, such that the selected controls are sufficient and effective to ensure regulatory compliance for a target system. This in turn can provide for a robust and well-rounded compliance framework such that organizations can implement efficient data security practices, protect their customers' information, and navigate regulations with confidence, for example.

It is appreciated that methods and systems in accordance with the present disclosure can include various combination of the aspects and features described herein. That is, methods and systems in accordance with the present disclosure are not limited to the specific combinations of aspects and features specifically described herein, but also may include other combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is an example environment for implementing security controls in accordance with technology described herein.

FIG. 2 is a block diagram of an example system for implementing security controls in accordance with technology described herein.

FIG. 3 is a flow diagram of an example process for implementing security controls in accordance with technology described herein.

FIG. 4 illustrates block diagrams of example computing devices.

### DETAILED DESCRIPTION

The technologies described in this document provide an automated system for streamlining adherence to various compliance criteria associated with a particular system of an organization. Compliance criteria specified by regulatory authorities are often numerous and targeted for a wide range of systems. Compliance criteria that is applicable to a particular system is a function of characteristics of the particular system, and identifying the applicable criteria from a large pool of criteria is often challenging and time/resource-consuming. The technologies described herein allows for relevant security controls associated with a target system to be automatically identified based on the specific needs/characteristics of the target system. The identified security controls can be, for example, measures or actions relevant to the security and privacy criteria for applicable regulatory compliance. This in turn can reduce the complexity and time associated with conducting comprehensive risk assessments—as compared to manually selecting and implementing applicable security controls—and provide for a robust and well-rounded compliance framework. Implementing such a compliance framework can allow organizations to fortify their data security protocols, safeguard their customers' information, and confidently navigate regulatory requirements, for example, while reducing time and resource usage as compared to corresponding manual processes.

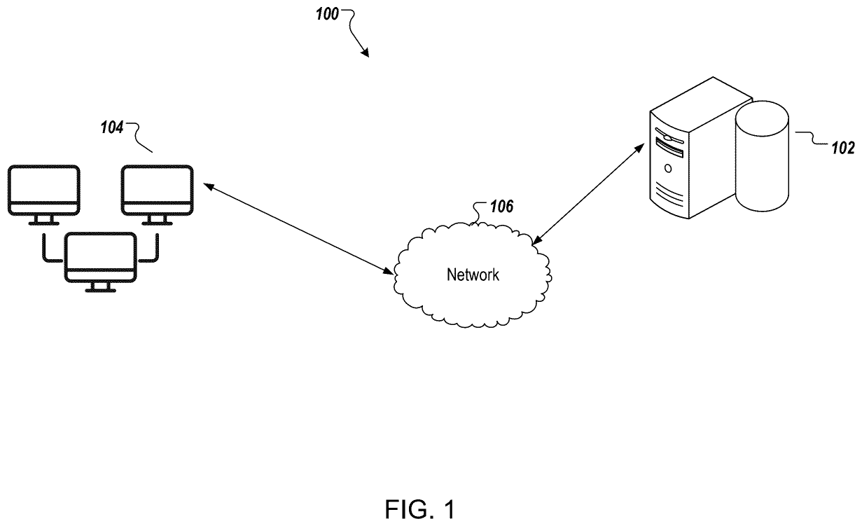

FIG. 1 is a block diagram of an example environment 100 for implementing security controls in accordance with technology described herein. The example environment 100 includes a computing system 102 including one or more computing devices, a target system 104, and a network 106. The network 106 can include a local area network (“LAN”), wide area network (“WAN”), the Internet, or a combination thereof. The network 106 is shown to illustrate that the computing system 102 and the target system 104 can be located at remote locations with respect to one another. In some implementations, the computing system 102 can be local with respect to the target system 104. For example, the computing system can be an edge device.

The target system 104 can include one or more computing devices, such as a server. The target system 104 can be a system associated with an organization that needs to comply with regulatory requirements. For example, the target system can be a system associated with a financial institution that needs to comply with Gramm-Leach-Bliley Act (GLBA). The regulatory requirements can be related to, and/or a function of, one or more attributes of the target system 104. The attributes of the target system 104 can include, for example, industry sector, business size, geographical location, regulatory environment, types of data, technology infrastructure, organizational structure, and the like. In some implementations, the target system 104 can be associated with a database that stores the profile and attributes of the target system 104. The database can store other data of the target system 104, such as the system files, operating data, transaction data, user data, application data, and the like.

In some implementations, the computing system 102 can comprise a compliance engine that monitors the target system 104 to ensure regulatory compliance. For example, the computing system can obtain the attributes of the target system 104. And based on the attributes of the target system 104, the computing system 102 can determine a plurality of security and privacy criteria associated with maintaining compliance with the regulatory requirements. For example, if the target system is for financial industry, the computing system 102 can determine that the security and privacy criteria are associated with maintaining compliance with the GLBA.

In some implementations, the computing system 102 can identify, from a set of security controls, a subset of security controls in accordance with the plurality of security and privacy criteria. The set of security controls include, for example, pre-defined security controls related to cyber security. For example, the set of controls can be the center for internet security (CIS) controls. These security controls are a set of actions to help organizations prevent and mitigate cyber threats, enhance cybersecurity posture and protect critical information and system. For example, the set of controls can include fundamental security practices that an organization can implement to safeguard its systems and data effectively.

The subset of security controls can include, for example, the measures or actions relevant to the security and privacy criteria. In some implementations, the subset of security controls can be selected such that the selected subset represents the most effective measures or actions deemed to meet the security and privacy criteria. In some implementations, the computing system 102 can cross reference each of the plurality of security and privacy criteria with each control included in the set of security controls to determine a relevance. The computing system 102 can select the subset of security controls according to the relevance. In some implementations, the computing system 102 can train a machine learning model to identify a set of “best” or “most effective” controls from the set of security controls, based on the specific needs/characteristics of the target system 104.

In general, the machine learning (ML) model is iteratively trained, where, during an iteration, one or more parameters of the ML model are adjusted, and an output is generated based on the training data. For each iteration, a loss value is determined based on a loss function. The loss value represents a degree of accuracy of the output of the ML model. The loss value can be described as a representation of a degree of difference between the output of the ML model and an expected output of the ML model (the expected output being provided from training data). In some examples, if the loss value does not meet an expected value (e.g., is not equal to zero), parameters of the ML model are adjusted in another iteration of training. In some instances, this process is repeated until the loss value meets the expected value.

In some implementations, the computing system 102 can obtain the regulatory compliance requirements and the set of pre-defined security controls from third party systems (not shown). In some implementations, the computing system 102 can have the regulatory compliance requirements and the set of pre-defined security controls stored in a database associated with the computing system 102.

In some implementations, the computing system 102 can implement the subset of security controls to the target system 104. The computing system 102 can customize the subset of security controls according to the current security posture, e.g., current security status, and the environment of the target system 104. In some implementations, the computing system 102 can be configured to continuously monitor an effectiveness of the implemented security controls according to the target system's compliance with the regulatory requirements. For example, the computing system can periodically assess the security posture of the target system after implementing the security controls. The computing system can conduct audit and perform risk assessment to identify any new gaps between the security posture and the compliance requirements for the target system 104. The computing system 102 can adjust the security controls to remove the gaps. The computing system 102 can identify additional security controls to implement to the target system 104 and ensure the compliance with the regulatory requirements.

The computing system 102 can include one or more computing devices, such as a server. In some implementations, the number of computing devices may be scaled (e.g., increased or decreased) automatically as per the computation resources needed. In some implementations, the computing system 102 can implement cloud-based resources where the number of virtual machines commissioned depend on the required computational resource. The various functional components of the computing system 102 may be installed on one or more computers as separate functional components or as different modules of a same functional component. For example, the various components of the computing system 102 can be implemented as computer programs installed on one or more computers in one or more locations that are coupled to each through a network. In cloud-based systems for example, these components can be implemented by individual computing nodes of a distributed computing system.

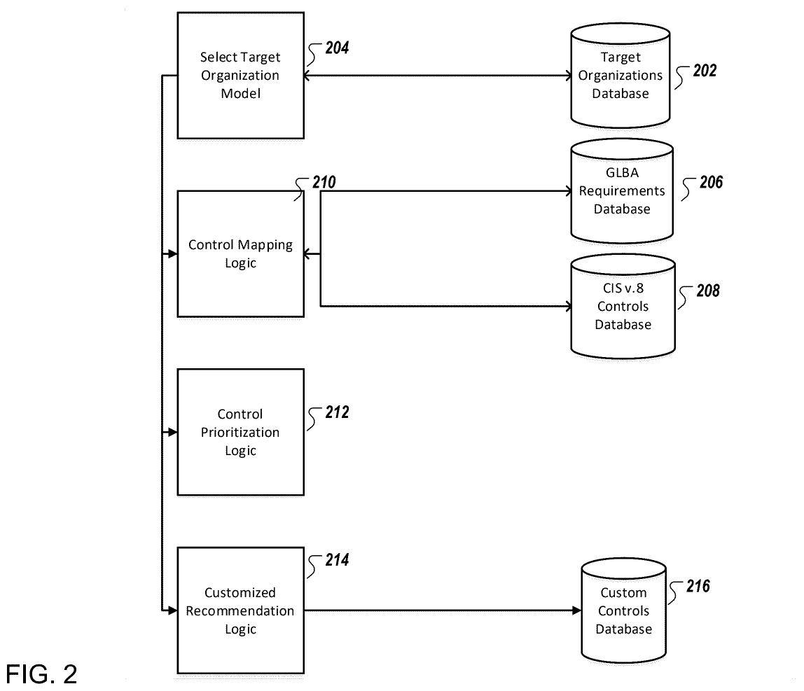

FIG. 2 shows block diagram of an example system 200 for implementing security controls in accordance with technology described herein. The system 200 is used as an example for implementing the security controls in a financial system. However, the technologies described in this document is not limited to financial systems.

The example system 200 can be the computing system 102 in FIG. 1. The computing system can obtain attributes of the target system from the target organization database 202. The computing system can select target organization model 204 based on the attributes of the target system. The target organization model 204 can include the regulatory compliance requirements, such as target protocols. In some implementations, the target protocols. For example, when the target system is for a final organization, the target protocols can include protocols specified in Gramm-Leach-Bliley Act (GLBA), which is a federal law in the United States that addresses the protection of customers' private financial information held by financial institutions.

The computing system can obtain the target protocols from the GLBA requirement database 206. To ensure compliance with the target protocols, the computing system can determine the security and privacy criteria to be met. Such criteria can include a range of standards, guidelines, or requirements used to assess, manage, and maintain a secure cyber environment of the target system. In some implementations, the criteria can be included in the GLBA requirements.

The computing system can obtain a set of security controls, such as center for internet security (CIS) controls from the CIS control database 208. The CIS controls are a set of cybersecurity measures and recommendations to address emerging cybersecurity challenges and improve resilience against cyber threats. The CIS controls include a set of pre-defined measures or actions for enhancing cybersecurity posture of computing systems.

In control mapping logic 210, the computing system can match the CIS controls to the target protocols for the GLBA requirements. Each CIS control can be a specific measure or action implemented to protect systems. Each target protocol can correspond to one or more security and privacy criteria to be met to ensure regulatory compliance with the GLBA requirements. In the mapping process, the computing system can identify a subset of security controls that are most effective to address the regulatory compliance, e.g., most effective in meeting the security and privacy criteria.

The computing system can further prioritize the subset of security controls using control prioritization logic 212. In some implementations, the control prioritization logic 212 can define which security controls are most relevant to the needs of the target system, based on the attributes of the target system. In some implementations, the control prioritization logic 212 can define which security controls have the greatest impacts, such as causing the greatest risks of non-compliance, if not implemented. The computing system can associate a priority to each of the subset of security controls, such that the subset of security controls is sorted in a decreasing order of the associated priorities. The computing system can implement the subset of security controls according to their priorities.

The computing system can customize the subset of security controls using customized recommendation logic 214. The customized recommendation logic 214 can define the rules for customizing the security controls according to the technology infrastructure and operational requirements of the target system. For example, the computing system can customize the security controls, such that the subset of security controls can align with the technological infrastructure and operational needs of the target system. In some implementations, the customized subset of security controls can be stored in the custom control database 216.

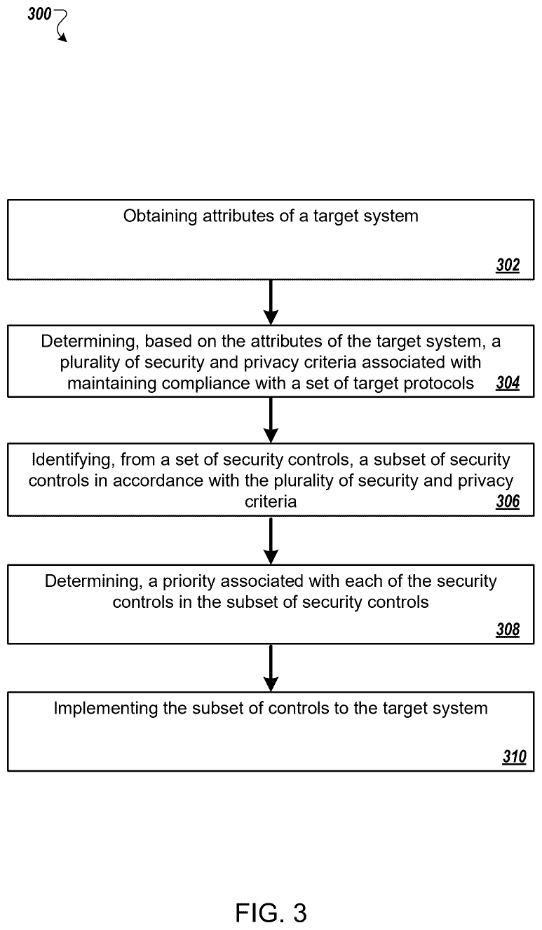

FIG. 3 is a flow diagram of an example process 300 for implementing security controls in accordance with technology described herein. In some implementations, at least a portion of the process 300 can be executed at the computing system 102.

At step 302, the computing system can obtain attributes of a target system. The target system can be the system of a target organization that needs to comply with a set of target protocols. The attributes of the target system can include industry sector, business size, geographical location, regulatory environment, types of data, technology infrastructure, organizational structure, and the like.

At step 304, the computing system can determine, based on the attributes of the target system, a plurality of security and privacy criteria associated with maintaining compliance with the set of target protocols.

In some implementations, the set of target protocols can include regulatory or legal compliance requirements for the target organization, such as the adherence of the target organization to laws, regulations, guidelines, and specifications relevant to the industry or area of operation. For example, the set of target protocols can include protocols specified in Gramm-Leach-Bliley Act (GLBA) for financial institutions.

Based on the attributes of the target system, the computing system can determine a plurality of security and privacy criteria associated with maintaining compliance with the set of target protocols. For example, the computing system can determine the specific security and privacy criteria that are relevant to the target organization based on the attributes of the target system. For instance, if the target system is a healthcare system, the security and privacy criteria may include standards for protecting sensitive patient health information from being disclosed without the patient's consent or knowledge. If the target system is a financial system, the security and privacy criteria may include standards for secure transaction processing, encryption of sensitive information, and continuous monitoring of systems.

Such criteria can include a range of standards, guidelines, or requirements used to assess, manage, and maintain a secure cyber environment of the target system. In some implementation, the plurality of security and privacy criteria can include the requirements for risk assessment, information security program, data protection, employee training, incident response, and the like.

At step 306, the computing system can identify, from a set of security controls, a subset of security controls in accordance with the plurality of security and privacy criteria.

The set of security controls include pre-defined security controls related to cyber security. For example, the set of controls can be the center for internet security (CIS) controls. These security controls are a set of actions to help organizations prevent and mitigate cyber threats, enhance cybersecurity posture and protect critical information and system. For example, the set of controls can include fundamental security practices that the target organization can implement to safeguard its systems and data effectively.

The security controls are the practical implementations, while the security and privacy criteria provide the benchmarks against which the security controls are measured for their efficacy, compliance, and alignment with security objectives.

The computing system can select, from the set of security controls, a subset of security controls that are most relevant to the target system, e.g., that can be used to satisfy the security and privacy criteria of the target system. More specifically, the computing system can cross reference each of the plurality of security and privacy criteria with each control included in the set of security controls to determine a relevance. The computing system can select the subset of security controls according to the relevance.

For example, in the cross-referencing process, the computing system can determine the relevance between each security and privacy criterion with each security control based on whether the security control can be used to satisfy the criterion. A security control can be a specific measure or action implemented to protect systems, data, networks, or information assets against potential threats. A security and privacy criterion can be a standard or requirement established to assess or measure the effectiveness, adequacy, or compliance of security controls. The relevance between the security and privacy criterion and the security control depends on whether the security control can be implemented to meet or fulfill the security and privacy criterion, and the extent to which the security control can meet the security and privacy criterion.

After determining the relevance, the computing system can select the subset of the security controls according to the relevance. For example, the computing system can select the security controls with a relevance satisfying a threshold. In some examples, the computing system can select a predetermined number of the security controls with the highest relevance, e.g., the top N relevant security controls. The subset of security controls can include the measures or actions that are most relevant to the security and privacy criteria. That is the subset of security controls are the most effective measures or actions to meet the security and privacy criteria.

In some implementations, the computing system can train a ML model to identify the subset of security controls including the “best” or “most effective” controls, from the set of security controls. The ML model can be trained to account for the specific needs/characteristics of the target system. Specifically, by analyzing the particular characteristics and needs of the target system, the machine learning model can identify and select, from the set of predetermined security controls, a subset of security controls that are most relevant and effective for the target system.

At step 308, the computing system can determine a priority associated with each of the security controls in the subset of security controls. The priority for each security control can be determined based on the attributes of the target system and the relationship of the security control with set of the target protocols.

Each security control in the subset of security controls can be used to satisfy one or more security and privacy criteria to ensure compliance with the target protocols. For example, one security control can be data encryption to ensure data privacy. Another security control can be intrusion detection to ensure network security. The importance level of each security control can be different. The importance level of each security control may depend on the needs of the target system and the risks or impacts of non-compliance with the target protocols. The computing system can determine a priority for each security control reflecting the importance level.

In some implementations, the priority for each of the subset of security controls can be determined based on the needs of the target system that are relevant to the attributes of the target system's attributes, e.g., industry sector, business size, geographical location, regulatory environment, types of data, technology infrastructure, organizational structure, and the like.

In some implementations, the priority for each of the subset of the security controls can be determined based on the relationship of the security control with the target protocols. While each security control can satisfy one or more security and privacy criteria to maintain compliance with the target protocols, the impacts of the security control can be different. Impacts can indicate the extent and effectiveness in addressing the issues required in the target protocols. For example, the impacts can include the extent of addressing the sensitivity of data, potential threats, vulnerabilities, the risks of non-compliance with the target protocols. The computing device can determine a higher priority based on the greater impacts of the security control.

At step 310, the computing system can implement the subset of security controls to the target system. In some implementations, the computing system can customize the subset of security controls using technology infrastructure and operational requirements of the target system. For example, the computing system can customize the security controls according to the specific security posture and the environment of the target system including the size, complexity, industry, and unique characteristic of the target system model. So that the subset of security controls can align with the technological infrastructure and operational needs of the target system.

In some implementations, the computing system can determine an implementation plan for the subset of security controls. For example, the computing system can assess the current level of compliance, define the gaps in compliance, assign responsibilities, set timelines, define milestones, and allocate the resources for implementing the subset of security controls.

After implementing the subset of security controls, the computing system can continuously monitor an effectiveness of the implemented security controls according to the target system's compliance with the set of target protocols. For example, the computing system can periodically assess the security posture of the target system after implementing the security controls. The computing system can conduct audit and perform risk assessment to identify any new gaps between the security posture and the compliance requirements of the target protocols. The computing system can identify the security controls that may have drifted from their original intent and efficacy over time or areas for improvement. The computing system can identify additional security controls to implement to the target system and ensure the compliance with the target protocols.

The order of steps in the process 300 described above is illustrative only, and the process 300 can be performed in different orders. In some implementations, the process 300 can include additional steps, fewer steps, or some of the steps can be divided into multiple steps.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed on a system of one or more computers in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

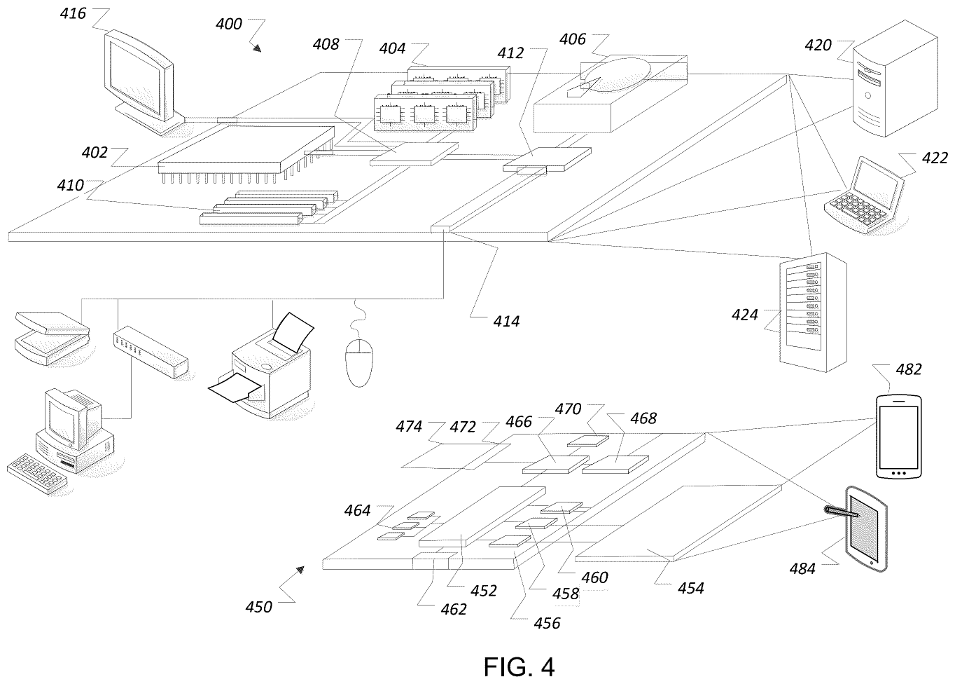

FIG. 4 shows an example of a computing device 400 and a mobile computing device 450 (also referred to herein as a wireless device) that are employed to execute implementations of the present disclosure. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 400 can form at least a portion of the computing system 102.

The computing device 400 includes a processor 402, a memory 404, a storage device 406, a high-speed interface 408, and a low-speed interface 412. In some implementations, the high-speed interface 408 connects to the memory 404 and multiple high-speed expansion ports 410. In some implementations, the low-speed interface 412 connects to a low-speed expansion port 414 and the storage device 406. Each of the processor 402, the memory 404, the storage device 406, the high-speed interface 408, the high-speed expansion ports 410, and the low-speed interface 412, are interconnected using various buses, and may be mounted on a common motherboard or in other manners as appropriate. The processor 402 can process instructions for execution within the computing device 400, including instructions stored in the memory 404 and/or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of a computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 402, perform one or more methods, such as those described above. The instructions can also be stored by one or more storage devices, such as computer-readable or machine-readable mediums, such as the memory 404, the storage device 406, or memory on the processor 402.

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards. In the implementation, the low-speed interface 412 is coupled to the storage device 406 and the low-speed expansion port 414. The low-speed expansion port 414, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 414 through a network adapter. Such network input/output devices may include, for example, a switch or router.

The computing device 400 may be implemented in a number of different forms, as shown in the FIG. 4. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may contain one or more of the computing device 400 and the mobile computing device 450, and an entire system may be made up of multiple computing devices communicating with each other.

The mobile computing device 450 includes a processor 452; a memory 464; an input/output device, such as a display 454; a communication interface 466; and a transceiver 468; among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate. In some implementations, the mobile computing device 450 may include a camera device(s) (not shown).

The processor 452 can execute instructions within the mobile computing device 450, including instructions stored in the memory 464. The processor 452 may be implemented as a chipset of chips that include separate and multiple analog and digital processors. For example, the processor 452 may be a Complex Instruction Set Computers (CISC) processor, a Reduced Instruction Set Computer (RISC) processor, or a Minimal Instruction Set Computer (MISC) processor. The processor 452 may provide, for example, for coordination of the other components of the mobile computing device 450, such as control of user interfaces (UIs), applications run by the mobile computing device 450, and/or wireless communication by the mobile computing device 450.

The processor 452 may communicate with a user through a control interface 458 and a display interface 456 coupled to the display 454. The display 454 may be, for example, a Thin-Film-Transistor Liquid Crystal Display (TFT) display, an Organic Light Emitting Diode (OLED) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a Single in Line Memory Module (SIMM) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 452, perform one or more methods, such as those described above. The instructions can also be stored by one or more storage devices, such as one or more computer-readable or machine-readable mediums, such as the memory 464, the expansion memory 474, or memory on the processor 452. In some implementations, the instructions can be received in a propagated signal, such as, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 468 using a radio frequency. In addition, short-range communication, such as using a Bluetooth or Wi-Fi, may occur. In addition, a Global Positioning System (GPS) receiver module 470 may provide additional navigation—and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in FIG. 4. Other implementations may include a phone device 482 and a tablet device 484. The mobile computing device 450 may also be implemented as a component of a smart-phone, personal digital assistant, AR device, or other similar mobile device.

Computing device 400 and/or 450 can also include USB flash drives. The USB flash drives may store operating systems and other applications. The USB flash drives can include input/output components, such as a wireless transmitter or USB connector that may be inserted into a USB port of another computing device. Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining, by one or more computing devices, attributes of a target system;
determining, based on the attributes of the target system, a plurality of security and privacy criteria associated with maintaining compliance with a set of target protocols;
identifying, from a set of security controls, a subset of security controls in accordance with the plurality of security and privacy criteria;
determining a priority associated with each of the security controls in the subset of security controls, wherein the priority for each of the security controls is determined based on the attributes of the target system and relationships of the security control with the set of target protocols; and
implementing the subset of security controls to the target system.

2. The computer-implemented method of claim 1, wherein the plurality of security and privacy criteria comprise requirements for risk assessment, information security program, data protection, employee training, and incident response.

3. The computer-implemented method of claim 1, wherein the set of security controls comprise pre-defined security controls related to cyber security.

4. The computer-implemented method of claim 1, wherein selecting the subset of security controls comprising:
cross referencing each of the plurality of security and privacy criteria with each control included in the set of security controls to determine a relevance; and
selecting the subset of security controls according to the relevance.

5. The computer-implemented method of claim 1, further comprising:
customizing the subset of security controls using technology infrastructure and operational requirements of the target system.

6. The computer-implemented method of claim 1, further comprising:
determining an implementation plan for the subset of security controls comprising:
assessing current level of compliance, defining gaps in compliance, assigning responsibilities, setting timelines, defining milestones, and allocating resources.

7. The computer-implemented method of claim 1, further comprising:
continuously monitoring an effectiveness of the implemented subset of security controls according to the target system's compliance with the set of target protocols after implementing the subset of security controls.

8. A non-transitory computer-readable medium encoded with instructions that, when executed by one or more computers, cause the one or more computers to perform operations comprising:
obtaining attributes of a target system;
determining, based on the attributes of the target system, a plurality of security and privacy criteria associated with maintaining compliance with a set of target protocols;
identifying, from a set of security controls, a subset of security controls in accordance with the plurality of security and privacy criteria;
determining a priority associated with each of the security controls in the subset of security controls, wherein the priority for each of the security controls is determined based on the attributes of the target system and relationships of the security control with the set of target protocols; and
implementing the subset of security controls to the target system.

9. The non-transitory computer-readable medium of claim 8, wherein the plurality of security and privacy criteria comprise requirements for risk assessment, information security program, data protection, employee training, and incident response.

10. The non-transitory computer-readable medium of claim 8, wherein the set of security controls comprise pre-defined security controls related to cyber security.

11. The non-transitory computer-readable medium of claim 8, wherein selecting the subset of security controls comprising:
cross referencing each of the plurality of security and privacy criteria with each control included in the set of security controls to determine a relevance; and
selecting the subset of security controls according to the relevance.

12. The non-transitory computer-readable medium of claim 8, wherein the operations comprise:
customizing the subset of security controls using technology infrastructure and operational requirements of the target system.

13. The non-transitory computer-readable medium of claim 8, wherein the operations comprise:
determining an implementation plan for the subset of security controls comprising:
assessing current level of compliance, defining gaps in compliance, assigning responsibilities, setting timelines, defining milestones, and allocating resources.

14. The non-transitory computer-readable medium of claim 8, wherein the operations comprise:
continuously monitoring an effectiveness of the implemented subset of security controls according to the target system's compliance with the set of target protocols after implementing the subset of security controls.

15. A system comprising one or more computers and one or more storage devices on which are stored instructions that are operable, when executed by the one or more computers, to cause the one or more computers to perform operations comprising:
obtaining attributes of a target system;
determining, based on the attributes of the target system, a plurality of security and privacy criteria associated with maintaining compliance with a set of target protocols;
identifying, from a set of security controls, a subset of security controls in accordance with the plurality of security and privacy criteria;
determining a priority associated with each of the security controls in the subset of security controls, wherein the priority for each of the security controls is determined based on the attributes of the target system and relationships of the security control with the set of target protocols; and
implementing the subset of security controls to the target system.

16. The system of claim 15, wherein the plurality of security and privacy criteria comprise requirements for risk assessment, information security program, data protection, employee training, and incident response, and wherein the set of security controls comprise pre-defined security controls related to cyber security.

17. The system of claim 15, wherein selecting the subset of security controls comprising:
cross referencing each of the plurality of security and privacy criteria with each control included in the set of security controls to determine a relevance; and
selecting the subset of security controls according to the relevance.

18. The system of claim 15, wherein the operations comprise:
customizing the subset of security controls using technology infrastructure and operational requirements of the target system.

19. The system of claim 15, wherein the operations comprise:
determining an implementation plan for the subset of security controls comprising:
assessing current level of compliance, defining gaps in compliance, assigning responsibilities, setting timelines, defining milestones, and allocating resources.

20. The system of claim 15, wherein the operations comprise:
continuously monitoring an effectiveness of the implemented subset of security controls according to the target system's compliance with the set of target protocols after implementing the subset of security controls.
